(19) United States
(12) Patent Application Publication
(10) Pub. No.: US 2026/0367241 A1
(43) Pub. Date: Nov. 19, 2026

(54) MACHINE SYSTEM AND RADAR REFLECTOR ASSEMBLY FOR SAME

(71) Applicant: Caterpillar Inc., Peoria, IL (US)

(72) Inventors: David Eric Munson, West Peoria, IL (US); Liliana Olaru, Peoria, IL (US)

(73) Assignee: Caterpillar Inc., Peoria, IL (US)

(21) Appl. No.: 19/211,537

(22) Filed: May 19, 2025

(51) Int. Cl. G01S 13/75; B60R 11/00; G01S 13/931

(52) U.S. Cl. CPC G01S 13/75; B60R 11/00; G01S 13/931; B60R 2011/004; G01S 2013/9329

(57) ABSTRACT

A machine system includes a first off-highway machine having a frame, ground- engaging propulsion elements, and an object detection system having a radar emitter and a reflected radar detector. The system further includes a second machine having a frame, ground- engaging propulsion elements, and a radar visibility system. The radar visibility system includes a plurality of radar reflector assemblies mounted at a plurality of locations upon the second machine. At least one of the plurality of radar reflector assemblies includes a housing and a plurality of polyhedral radar reflectors arranged in a stack within the housing.

### TECHNICAL FIELD

The present disclosure relates generally to object detection at a mine or other off-highway work site, and more particularly to a radar reflector assembly for improving visibility of an object to an object detection system of a machine.

### BACKGROUND

Off-highway machines often operate in extremely rugged environments. A premium is typically placed upon the capacity to maximize an amount of material that is moved in a given period of time, coupled with factors such as energy efficiency and limiting wear and tear on the machine. As a result, mining and certain other off-highway environments often utilize large, relatively fast-moving machines, some of which may be autonomous or semi-autonomous, and whose operations must be coordinated for optimal efficiency. Various service vehicles traveling throughout the work site, and potential hazards such as obstacles and/or slopes, piles, and restricted areas can render the coordinated navigation of machines without incident a complex endeavor.

A variety of object detection strategies to avoid collisions or travel into or over off-limits areas are used in connection with heavy machinery, ranging from operator use of mirrors to various computerized scanning systems. United States Patent No. 9,457,718 to Husted et al. proposes an object detection system that utilizes an alert system and a controller that stores an electronic map containing a known obstacle as well as known or unknown obstacles warning zones. An object in proximity to a machine is detected, and an alert generated under certain conditions. While the Husted strategy likely functions well for intended purposes, the art provides ample room for improvements and development of alternative strategies.

In one aspect, a machine system includes a first off-highway machine having a frame, ground-engaging propulsion elements, and an object detection system having a radar emitter and a reflected radar detector. The system further includes a second machine having a frame, ground-engaging propulsion elements, and a radar visibility system. The radar visibility system includes a plurality of radar reflector assemblies mounted at a plurality of locations upon the second machine, and at least one of the plurality of radar reflector assemblies includes a housing and a plurality of polyhedral radar reflectors arranged in a stack within the housing.

In another aspect, a radar reflector assembly includes a mount configured to be secured to an object, a housing configured to couple to the mount, and a plurality of polyhedral radar reflectors positioned in the housing in a stacked arrangement and configured to increase visibility of the object to an off-highway machine having ground-engaging propulsion elements and an object detection system having a radar emitter and a reflected radar detector.

In still another aspect, a radar reflector system for improving object detectability at an off-highway work site includes a plurality of radar reflector assemblies for mounting to an object at the work site. The plurality of radar reflector assemblies includes a first assembly having a first housing, a first mount for mounting at a first location on the object, and at least one polyhedral radar reflector in the first housing. The plurality of radar reflector assemblies further includes a second assembly having a second housing, a second mount for mounting at a second location on the object, and a plurality of polyhedral radar reflectors arranged in a stack in the second housing.

### BRIEF DESCRIPTION OF DRAWINGS

FIG. 1 is a diagrammatic view of a machine system, according to one embodiment;

FIG. 2 is a diagrammatic of a machine system, according to one embodiment;

FIG. 3 is a diagrammatic view of a radar reflector assembly, according to one embodiment;

FIG. 4 is a diagrammatic view of a cube-shaped radar reflector;

FIG. 5 is a diagrammatic view showing a stacked arrangement of radar reflectors, according to one embodiment;

FIG. 6 is a diagrammatic view of a radar reflector assembly in a mounting arrangement, according to one embodiment;

FIG. 7 is a diagrammatic view of mounting components for a radar reflector assembly, according to one embodiment;

FIG. 8 is a diagrammatic view of a radar reflector assembly in another mounting arrangement, according to one embodiment; and

FIG. 9 is a diagrammatic view of a radar reflector assembly in yet another mounting arrangement, according to one embodiment.

### DETAILED DESCRIPTION

Inertia of an off-highway machine, such as a fully loaded mining truck, can be a concern due to the immense mass and momentum possessed when in motion. The inertia can make it challenging for the machine to quickly stop or change direction, with such challenges being compounded where steep grades, narrow roads, tight corners, and unexpected obstacles come into play. Along with multiple heavy mining vehicles or equipment, mine sites also tend to have smaller vehicles that support the overall mining operation. Such smaller vehicles, for example, light-duty trucks and SUVs are needed for transporting supervisors, engineers, project managers, geologists, maintenance crews, safety personnel, and other staff across the mine site.

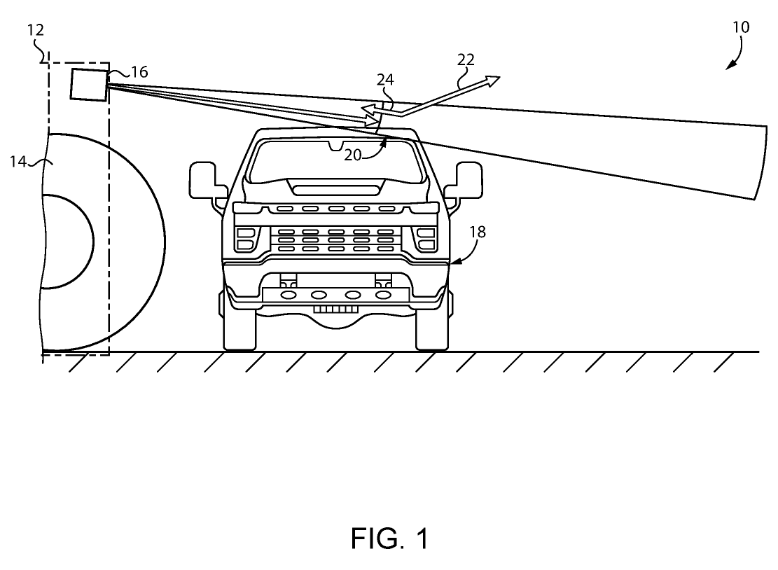

Referring now to FIG. 1, there is shown a machine system 10 including a first machine 12 showing a wheel 14 thereof. First machine 12 may include a large mining vehicle such as a mining truck equipped for hauling ore or another material and having ground-engaging elements such as wheels. Other off-highway machines in the context of the present disclosure could include track-type tractors, scrapers, motor graders, articulated trucks, and still others. An object detection system 16 including a combination of a radar emitter and a radar detector is mounted on machine 12. In some embodiments, a radar detector could be mounted at a separate location distant from the radar emitter. A second machine 18, including a smaller vehicle such as a light-duty truck is situated in front of wheel 14. A radar reflector 20 is mounted on a front top corner of machine 18 (roof-mounted) and forms at least part of a radar visibility system.

The radar emitter of object detection system 16 may continuously, or periodically, emit a radar signal in front of, in back of, to the sides, and/or around machine 12. When machine 18 appears in front of, in back of, or otherwise in proximity to machine 12, then radar reflector 20 may reflect the received radar signals. Object detection system 16 may receive the radar signal reflected by radar reflector 20.

An angle at which radar reflector 20 sends a reflected radar signal and an angle at which object detection system 16 receives the reflected signal can play a role in whether machine 12 will be able to detect the presence of machine 18. In the illustrated example, a large portion 22 of the emitted radar signal may be reflected away due to an oblique angle of radar reflector 20 to the emitted radar. A smaller, or zero, portion 24 of the reflected radar signal may be returned from radar reflector 20 and actually sensed via the radar detector of object detection system 16. As a result, machine 18 may not be visible to machine 12, or may not become visible soon enough to avoid a collision. Moreover, while some machines include machine components and/or systems theoretically visible to radar apart from being dedicated radar reflectors, such as vehicle body panels, a frame, or an engine, certain machines may lack such structures and/or be equipped with non-metallic components or the like that are not readily visible to radar.

To mitigate the risk of smaller vehicles or other objects going undetected, the present disclosure provides radar reflector assemblies, systems, and kits for equipping a machine such as machine 18 for improved visibility to radar. Thus, machine system 10 may include machine 12 equipped with object detection system 16, and machine 18 equipped with additional and/or alternative radar reflector assemblies as further discussed herein. According to the present disclosure, machines according to the present disclosure may be equipped with a plurality of radar reflector assemblies mounted at a plurality of locations thereon, as also further discussed herein.

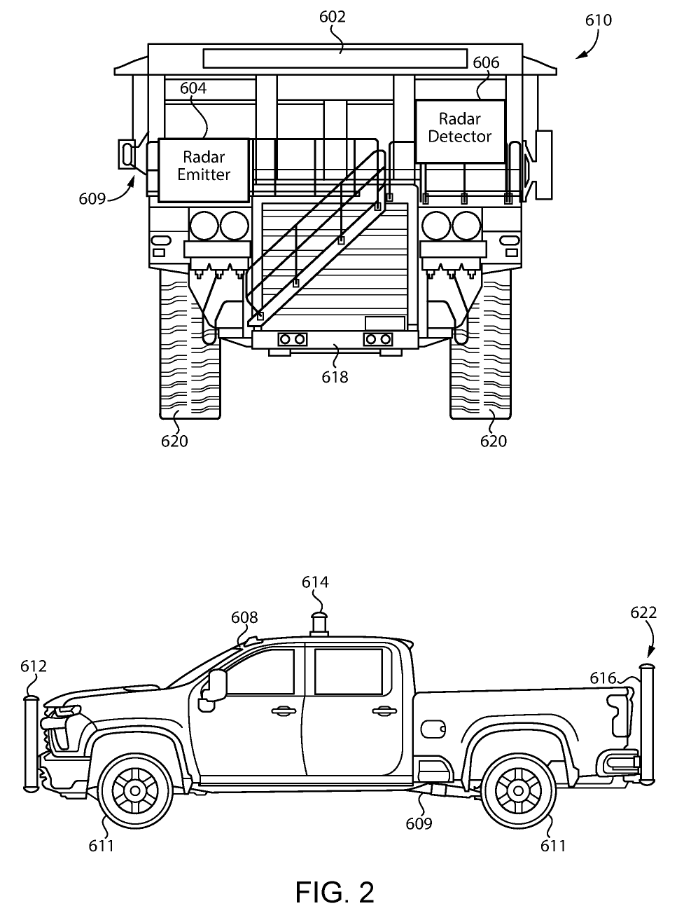

Turning now to FIG. 2, there is shown a diagrammatic view of a machine system 610 similar to machine system 10, including a first off-highway machine 609 having a frame 618, ground-engaging propulsion elements 620, and an object detection system including a radar emitter 604 and a radar detector 606. Machine system 610 also includes a second machine 608 also have a frame 609, ground-engaging propulsion elements 611, and a radar visibility system 622.

Radar visibility system 622 includes a forward or front end-mounted radar reflector assembly 612, a rearward or back end-mounted radar reflector assembly 616, and a top or roof-mounted radar reflector assembly 614. Thus, in the illustrated embodiment radar visibility system 622 includes three radar reflector assemblies. Less than three or more than could be used in other embodiments. Moreover, the mounting locations illustrated are exemplary only. Front radar reflector assembly 612 might be mounted to a bumper, a grill, or even a vehicle hood, for example. Back radar reflector assembly 616 might be mounted to a bumper, to a tailgate, in a truck bed, for example. Top radar reflector assembly 614 might be mounted upon the roof of machine 608 or elsewhere.

Further, radar reflector assemblies as contemplated herein might be vertically oriented, horizontally oriented, or even diagonally oriented depending upon the type of machine or other object to which they are mounted, and various other considerations including available surfaces or components upon a machine to which they may be mounted and mounts that are available to use. Rather than a single front-mounted assembly 612, in some instances two, three, or more radar reflector assemblies might be mounted at the front of a machine, and two, three, or more mounted at the back of a machine. Multiple radar reflector assemblies might be roof-mounted on a given vehicle.

At least one of the plurality of radar reflector assemblies in the example depicted in FIG. 2 includes a housing and a plurality of polyhedral radar reflectors arranged in a stack within the housing. A “polyhedral” radar reflector as contemplated herein means a radar reflector having multiple flat faces, such as a cube, a prism, a box, or a pyramid, or a radar that is at least partially cubic, prismatic, or pyramidal, for example. Other shapes that may be understood within the context of the present disclosure as polyhedral include other regular and non-regular solids, and open shapes having multiple flat faces. Three triangular flat plates joined at a common vertex may be understood as polyhedral, for example. The plurality of radar reflector assemblies may include among them a plurality of different configurations. The plurality of different configurations could include a different number of radar reflectors, a different shape of radar reflectors, a different type of housing, a different number of housings, or a different type of mount, for example.

A stack of polyhedral radar reflectors according to the present disclosure may include, for example, three to five layers of polyhedral radar reflectors, and in one implementation exactly four such layers. Each respective polyhedral radar reflector may have at least one square shaped surface in some embodiments. The at least one square-shaped surface might have, for example, a size that is from 2 inches to 6 inches square. In one practical implementation the at least one square shaped surface, and potentially all surfaces of a radar reflector is approximately 4 inches square. The term approximately can be understood in the context of conventional rounding, thus “approximately 4 inches” means from 3.5 to 4.4 inches. The present disclosure is not limited to any particular dimensions of a radar reflector or surface thereof; however, at least one 4 inch square surface, and potentially all six surfaces of a cube-shaped radar reflector is considered to provide a practical implementation for optimized visibility of an object to radar. In any given implementation, radar reflector assemblies might include one or more radar reflectors, with a vehicle typically equipped with a number, positioning, and type of a plurality of radar reflector assemblies that is considered to optimally provide 360⁰ of visibility to radar of the vehicle itself.

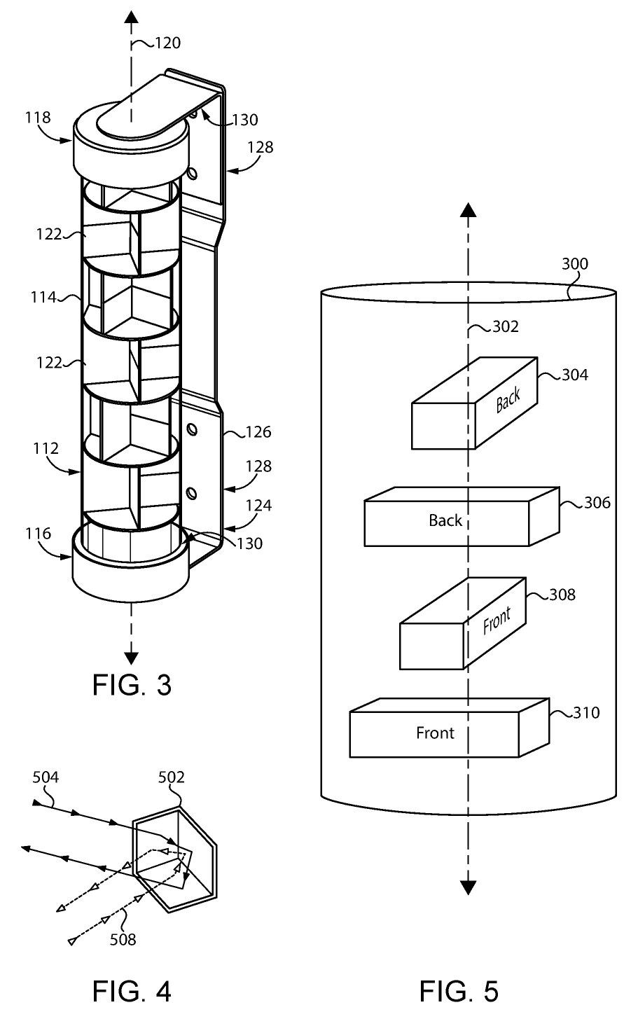

Referring also now to FIG. 3, there is shown an example radar reflector assembly 112 according to the present disclosure in further detail. Assembly 112 includes a housing 114 extending between a first, closed end 116 and a second, closed end 118 and defining a longitudinal axis 120. One or both of closed ends 116 and 118 may include an end cap or the like. Housing 114 itself may include a tube, including a transparent or translucent non-metallic tube, hosting a plurality of radar reflectors 122 therein.

Assembly 112 also includes a mount 124. In an embodiment, mount 124 includes a mounting spine 126. Mounting spine 126 may be metallic, such as a formed or machined metallic plate, profiled so as to define a plurality of housing attachment locations 128 and a plurality of object securement locations 130. In the illustrated embodiment, housing attachment locations 128 include planar sections of mounting spine 126 suitable for mounting to a vehicle, a pole, or another structure, and object securement locations 130 include protruding sections suitable for securing an object, that is housing 114, therebetween.

In other embodiments, a profile of a mounting spine could include forward or rearward protrusions, cutouts to receive mounting straps or other mounting elements for mounting the radar reflector assembly, stepped-off surfaces for attachment to a vehicle frame or vehicle component, or still other structural features. A mounting spine profiled according to the present disclosure may include some structural profile features for mounting the overall radar reflector assembly to a vehicle or other object, and some structural profile features for securing a housing of the radar reflector assembly.

FIG. 4 shows how a cube-shaped radar reflector 502 assists better reflection. A cube shape offers an ability to reflect radar signals over a wide range of angles. In other words, the reflector will tend to return a strong signal to the radar source even if the reflector is not in perfect alignment facing a radar source. As shown in FIG. 4, upon reaching radar reflector cube 502, a radar signal 508 emitted by a radar source is reflected back via a reflected signal 504. This ability for strong signal reflection strength without perfect alignment between the radar source and radar reflector can assist in improved visibility especially where vehicles and equipment are constantly moving and changing orientation, such as at a mine site. A cube shape thus offers an ability to reflect radar signals over a wide range of angles.

In one practical implementation, a radar reflector assembly may include a stack of three to five layers of polyhedral radar reflectors. Referring also now to FIG. 5, a plurality of polyhedral radar reflectors 304, 306, 308, and 310, four in total, are shown hosted in a housing or tube 300 defining a longitudinal axis 302. Within tube, radar reflectors 304, 306, 308, and 310 are stacked at a plurality of different angular orientations about axis 302. In this embodiment, a difference between the angular orientations about axis 302 of any two adjacent radar reflectors is 90⁰. As can be seen from FIG. 5, a number of the plurality of polyhedral radar reflectors is four, and an offset circumferentially around axis 302 is 90⁰. Thus, a clocking offset of the plurality of polyhedral radar reflectors about axis 302 is linked to a number of layers of the radar reflectors in the stack. Put differently, for four layers, a quarter turn clocking offset is used. For a different number of layers, a different clocking offset could be used, for example, for three layers the clocking offset might be 120⁰, for six layers the clocking offset might be 60⁰, and so on. Also in the illustrated embodiment, the plurality of polyhedral radar reflectors are interchangeable, and may be identical. Although shown generally as rectangular boxes, the plurality of polyhedral radar reflectors in the FIG. 5 embodiment might be cube-shaped, have rounded edges, or have still another shape. In any event, in a practical implementation the plurality of different angular orientation about an axis is contemplated to provide 360⁰ visibility of the object to which the tube is attached.

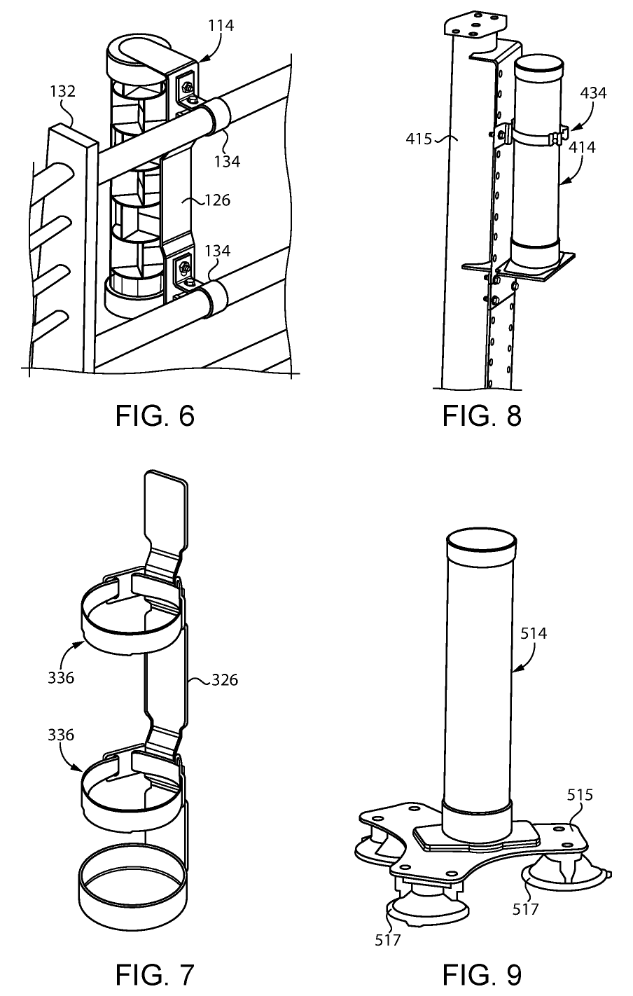

Turning now to FIG. 6, there is shown a radar reflector assembly 114 according to one embodiment and similar or identical to that shown in FIG. 3. In FIG. 4 assembly 114 is shown as it might appear mounted to a front grill 132 of a vehicle via a plurality of attachment elements 134. Attachment elements 134 may have the form of metal band clamps or the like that clamp mounting spine 126 to grill 132 via threaded fasteners, for example.

FIG. 7 shows yet another arrangement, including a mounting spine 326 coupled to two fastening bands 336 that are configured to extend around a housing of a radar reflector assembly. Fastening bands 336 could include hooks, buckles, snaps, hook and loop fasteners (Velcro®), or still other structures for coupling to a housing of a radar reflector assembly as contemplated herein. Fastening bands 336 may be adjustable to secure radar reflector assemblies of variable size/circumference in the nature of flexible straps or the like.

FIG. 8 shows yet another arrangement wherein a radar reflector assembly 414 is mounted to a mast or pole 415 via a band clamp 434 or other attachment element. The arrangement shown in FIG. 8 might be used, for example, to position a radar reflector assembly at the edge of a drop off, at the boundary of an exclusion zone, or at any other conceivable location or on any conceivable object it is desirable to make fully visible to an object detection system as contemplated herein.

FIG. 9 shows still another embodiment wherein a radar reflector assembly 514 is positioned upon a mount 515 that is equipped with suction cups 517 such as might be appropriate for mounting to the roof of a vehicle or a stationary object, for example.

### INDUSTRIAL APPLICABILITY

Referring to the drawings generally, it is contemplated that a machine system at an off-highway work site can be equipped for improved visibility of objects to radar by providing a kit or system having a variety of different radar reflector assemblies suited for a variety of different applications. In one instance, a kit might include a plurality of radar reflector assemblies to be mounted upon a vehicle including multiple different mounts for multiple different mounting locations and/or supporting structures on the vehicle. One example includes a system having a first radar reflector assembly and a first mount for roof-mounting, a second radar reflector assembly and a second mount for front-end mounting such as to a front grill or bumper, and a third radar reflector assembly and a third mount for back-end mounting such as to a rear bumper or tailgate. Some implementations could include a plurality of different straps, clamps, bands, and mounting hardware such that each radar reflector assembly can be appropriately mounted with consideration for differing vehicle structures such as different grill types. Some systems may also be equipped for pole or mast mounting, including a pole or mast having a base configured to support the pole or mast on or in an underlying substrate. In view of the present disclosure those skilled in the art will likely envision various extensions and modifications around these general principles.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A machine system comprising:
a first off-highway machine having a frame, ground-engaging propulsion elements, and an object detection system having a radar emitter and a reflected radar detector;
a second machine having a frame, ground-engaging propulsion elements, and a radar visibility system; and
the radar visibility system having a plurality of radar reflector assemblies mounted at a plurality of locations upon the second machine, and at least one of the plurality of radar reflector assemblies including a housing and a plurality of polyhedral radar reflectors arranged in a stack within the housing.

2. The machine system of claim 1 wherein the plurality of radar reflector assemblies include among them a plurality of different configurations including at least one of a different number of radar reflectors, a different shape of radar reflectors, a different type of housing, or a different type of mount.

3. The machine system of claim 1 wherein the stack includes three to five layers of the polyhedral radar reflectors.

4. The machine system of claim 3 wherein each of the polyhedral radar reflectors includes at least one square shaped surface.

5. The machine system of claim 1 wherein the radar visibility system includes a mounting spine coupling the at least one of the radar reflector assemblies to the second machine.

6. The machine system of claim 1 wherein the housing includes a tube defining a longitudinal axis, and within the stack the plurality of polyhedral radar reflectors are arranged at a plurality of different angular orientations about the longitudinal axis.

7. The machine system of claim 6 wherein the plurality of polyhedral radar reflectors are interchangeable, and the plurality of different angular orientations define a clocking offset of the plurality of polyhedral radar reflectors about the axis that is linked to a number of layers of the plurality of polyhedral radar reflectors in the stack.

8. A radar reflector assembly comprising:
a mount configured to be secured to an object;
a housing configured to couple to the mount; and
a plurality of polyhedral radar reflectors positioned in the housing in a stacked arrangement and configured to increase visibility of the object to an off-highway machine having ground-engaging propulsion elements and an object detection system having a radar emitter and a reflected radar detector.

9. The radar reflector assembly of claim 8 wherein the mount includes a mounting spine profiled so as to define a plurality of housing attachment locations and a plurality of object securement locations.

10. The radar reflector assembly of claim 9 wherein the housing includes a nonmetallic tube attached to the mounting spine via a set of attachment elements at the plurality of housing attachment locations.

11. The radar reflector assembly of claim 10 wherein the tube defines a longitudinal axis, and wherein the plurality of polyhedral radar reflectors are positioned at a plurality of different angular orientations about the axis so as to provide 360⁰ radar visibility of the object to the off-highway machine.

12. The radar reflector assembly of claim 8 wherein the plurality of polyhedral radar reflectors are arranged in a plurality of layers.

13. The radar reflector assembly of claim 12 wherein the plurality of polyhedral radar reflectors are from 2 inches to 6 inches square.

14. A radar reflector system for improving object detectability at an off-highway work site comprising:
a plurality of radar reflector assemblies for mounting to an object at the work site, and including a first assembly having a first housing, a first mount for mounting at a first location on the object, and at least one polyhedral radar reflector in the first housing; and
the plurality of radar reflector assemblies further including a second assembly having a second housing, a second mount for mounting at a second location on the object, and a plurality of polyhedral radar reflectors arranged in a stack in the second housing.

15. The radar reflector system of claim 14 wherein the first mount includes a vehicle roof mount, and the second mount includes a vehicle end mount.

16. The radar reflector system of claim 15 wherein the vehicle end mount includes a mounting spine, and the housing includes a non-metallic tube defining a longitudinal axis.

17. The radar reflector system of claim 16 wherein the mounting spine is profiled so as to define a plurality of housing attachment locations and a plurality of object securement locations, and further comprising a plurality of fastening elements configured to fasten the housing to the mounting spine at the plurality of housing attachment locations.

18. The radar reflector system of claim 16 wherein the plurality of polyhedral radar reflectors are arranged at a plurality of different angular orientations about the longitudinal axis.

19. The radar reflector system of claim 18 wherein the plurality of polyhedral radar reflectors are arranged in three to five layers in the stack.

20. The radar reflector system of claim 19 wherein the polyhedral radar reflectors are from 2 inches to 6 inches square.
